(19) United States
(12) Patent Application Publication
(10) Pub. No.: US 2026/0264594 A1
(43) Pub. Date: Sep. 10, 2026

(54) Head Restraint Assembly

(71) Applicant: Kongsberg Automotive Holding 2 AS, Kongsberg (NO)

(72) Inventor: Anders Kvarnström, Jönköping (SE)

(73) Assignee: Kongsberg Automotive Holding 2 AS, Kongsberg (NO)

(21) Appl. No.: 19/164,678

(22) PCT Filed: Mar. 15, 2023
(86) PCT No.: PCT/IB2023/052534

§ 371 Date: Sep. 12, 2025

(51) Int. Cl. B60N 2/859; B60N 2/853

(52) U.S. Cl. CPC B60N 2/859; B60N 2/853

(57) ABSTRACT

A head restraint assembly is disclosed. The head restraint assembly includes a frame. A shaft is coupled to the frame and is rotatable relative to the frame. An arm is coupled to the frame and is rotatable relative to the frame. The arm is rotatable to a lowered position and a raised position. A pawl is coupled to the shaft and is rotatable with the shaft about the shaft axis to an engaged position in which rotation of the arm from the raised position to the lowered position is prevented. The pawl is rotatable with the shaft to a released position in which rotation of the arm from the raised position to the lowered position is permitted. An actuator having an electric motor and a drive plunger rotates the shaft to move the pawl to the released position.

### BACKGROUND

Head restraint assemblies are often used in conjunction with head rest members and vehicle seat backs in vehicle seating to support an occupant's head while they are seated in the vehicle. The head restraint assemblies in rear seats are typically operable to move the head rest member to a lowered position to enhance rear visibility to the driver when rear passenger seats are vacant. Conventional head restraint assemblies frequently require manual actuation to move the head rest members to a lowered position. This arrangement may induce undesirable packaging constraints to facilitate accessible manipulation of the head restraint assembly by the user. Moreover, manual manipulation of the head restraint assembly to a lowered position may require the driver to exit the vehicle and enter through the rear passenger door to move the head restraint assemblies to the lowered position.

Therefore, there is a need in the art for a head restraint assembly capable of overcoming one or more of the aforementioned shortcomings.

### SUMMARY

A head restraint assembly is disclosed. The head restraint assembly comprises a frame. A shaft is coupled to the frame and is rotatable relative to the frame about a shaft axis. An arm is coupled to the frame and is rotatable relative to the frame about an arm axis to at least a lowered position and a raised position. The arm axis is spaced from the shaft axis. A pawl is coupled to the shaft and is rotatable with the shaft about the shaft axis to an engaged position in which rotation of the arm from the raised position to the lowered position is prevented. The pawl is rotatable with the shaft about the shaft axis to a released position in which rotation of the arm from the raised position to the lowered position is permitted. An actuator is coupled to the frame. The actuator has an electric motor and a drive plunger. Actuation of the drive plunger rotates the shaft to move the pawl to the released position.

A method of operating a head restraint assembly is further disclosed. The head restraint assembly has a frame, a shaft rotatable relative to the frame, an arm rotatable relative to the frame, a pawl rotatable relative to the frame, and an actuator coupled to the frame and having an electric motor and a drive plunger. The method may comprise the step of moving the drive plunger with the electric motor from a retracted position to an extended position to rotate the shaft about a shaft axis. The method may further include a step of rotating the pawl about the shaft axis to a released position to permit movement of the arm from a raised position to a lowered position.

Any of the above aspects can be combined in full or in part. Any features of the above aspects can be combined in full or in part. Any of the above implementations for any aspect can be combined with any other aspect. Any of the above implementations can be combined with any other implementation whether for the same aspect or a different aspect.

### BRIEF DESCRIPTION OF THE DRAWINGS

Advantages of the present disclosure will be readily appreciated as the same becomes better understood by reference to the following detailed description when considered in connection with the accompanying drawings.

FIG. 1 is a perspective view of a head restraint assembly coupled to a headrest member and a seat member.

FIG. 2 is an exploded view of the head restraint assembly of FIG. 1.

FIG. 3 is a partial perspective view of the head restraint assembly of FIG. 1.

FIG. 4 is a front elevation view of the head restraint assembly of FIG. 1 with arms of the head restraint assembly in raised positions.

FIG. 5A is a section view of the head restraint assembly taken along line 5-5 of FIG. 4 with a drive plunger of an actuator of the head restraint assembly in a retracted position and one of the arms of the head restraint assembly in a raised position.

FIG. 5B is a section view of the head restraint assembly taken along line 5-5 of FIG. 4 with the drive plunger of the actuator of the head restraint assembly in an intermediate position and one of the arms of the head restraint assembly in the raised position.

FIG. 5C is a section view of the head restraint assembly taken along line 5-5 of FIG. 4 with the drive plunger of the actuator of the head restraint assembly in an extended position and one of the arms of the head restraint assembly in the raised position.

FIG. 6A is a section view of the head restraint assembly taken along line 6-6 of FIG. 4 with a pawl of the head restraint assembly in an engaged position and one of the arms of the head restraint assembly in the raised position.

FIG. 6B is a section view of the head restraint assembly taken along line 6-6 of FIG. 4 with the pawl of the head restraint assembly in a released position and one of the arms of the head restraint assembly in the raised position.

FIG. 7 is a front elevation view of the head restraint assembly of FIG. 1 with the arms of the head restraint assembly in lowered positions.

FIG. 8 is a section view of the head restraint assembly taken along line 8-8 of FIG. 7 with the drive plunger of the actuator of the head restraint assembly in the retracted position and one of the arms of the head restraint assembly in the lowered position.

FIG. 9 is a section view of the head restraint assembly taken along line 9-9 of FIG. 7 with an abutment portion of the pawl of the head restraint assembly biased toward the arm and one of the arms of the head restraint assembly in the lowered position.

### DETAILED DESCRIPTION

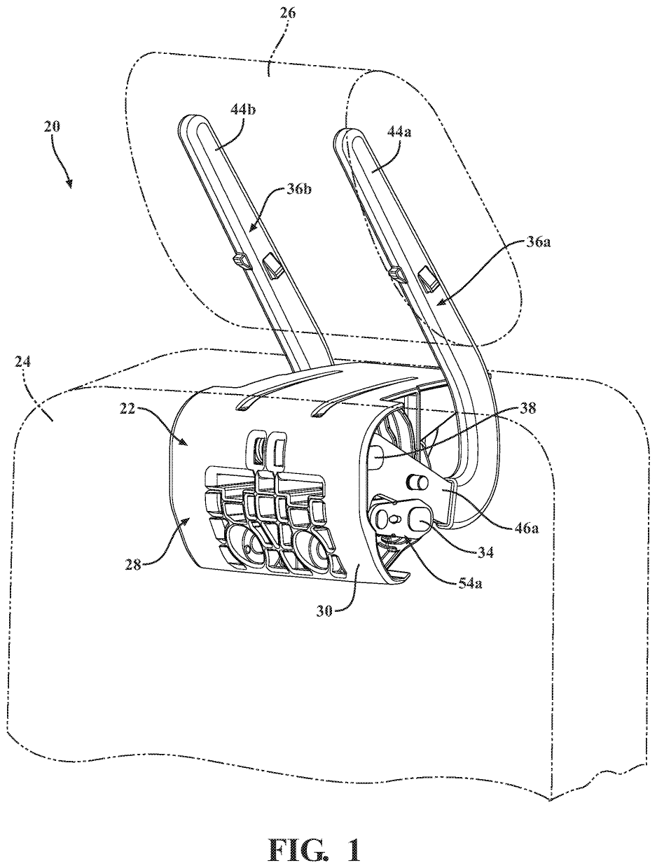

Referring to the environmental view in FIG. 1, a head restraint assembly 22 is illustrated in one exemplary configuration of a seat system 20 in a rear seat of a vehicle. The head restraint assembly 22 may alternatively be referred to as a head restraint mechanism. FIG. 1 illustrates the head restraint assembly 22 coupled to a seat back member 24 and a head rest member 26. More specifically, the head restraint assembly 22 couples the head rest member 26 to the seat back member 24 and facilitates movement of the headrest member 26 relative to the seat back member 24. When there are no passengers in the rear seat of the vehicle, it is beneficial to move the head rest member 24 to increase the driver's rear visibility in the vehicle. However, it is contemplated that the head restraint assembly 22 may be employed with any seat in the vehicle.

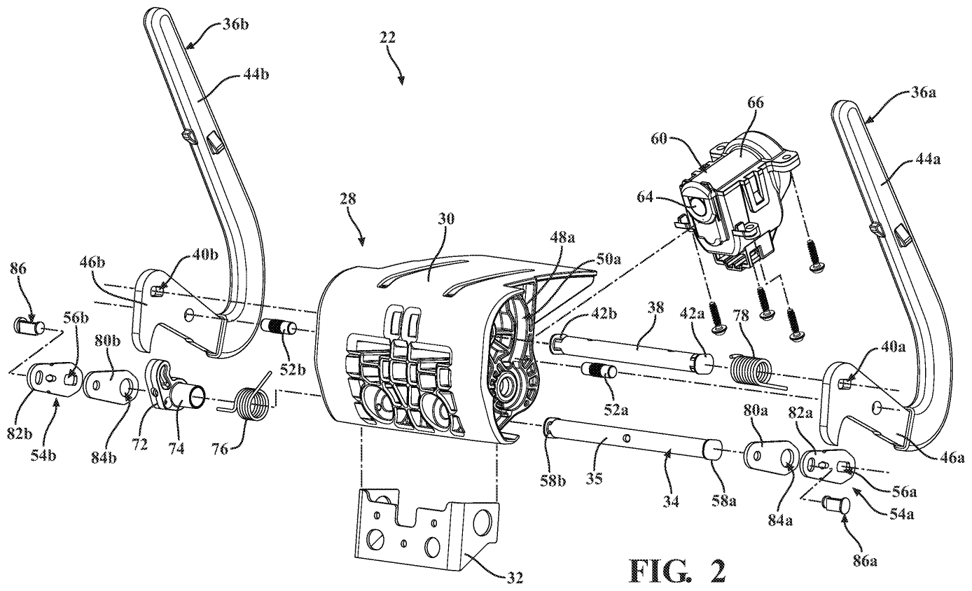

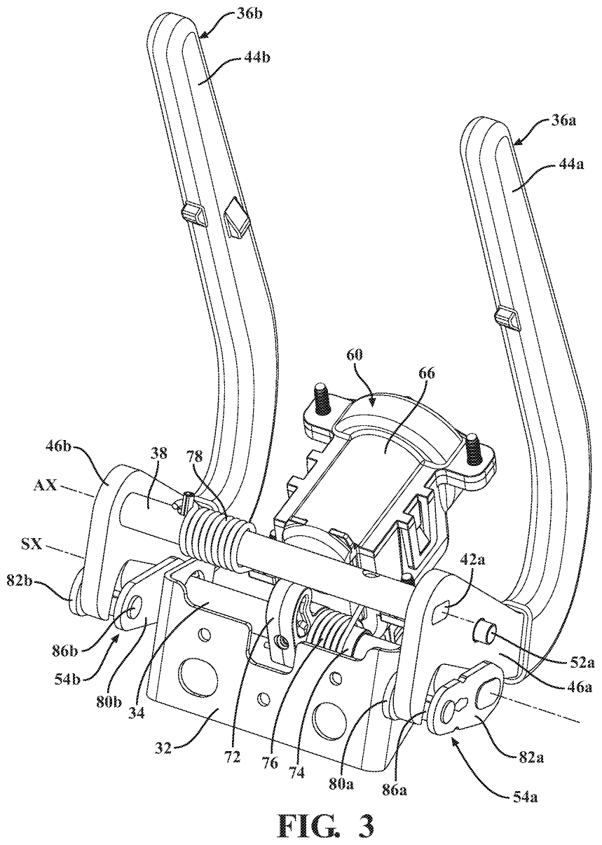

As shown in FIG. 1, the head restraint assembly 22 includes a frame 28. The frame 28 may comprise a single rigid component. In other configurations, the frame 28 may comprise multiple components secured together. In the configuration illustrated in FIG. 1, the frame comprises a housing member 30 and a bracket member 32 (shown FIGS. 2 and 3). The housing member 30 and the bracket member 32 are rigidly secured together. In some configurations, the bracket member 32 is molded into the housing member 30.

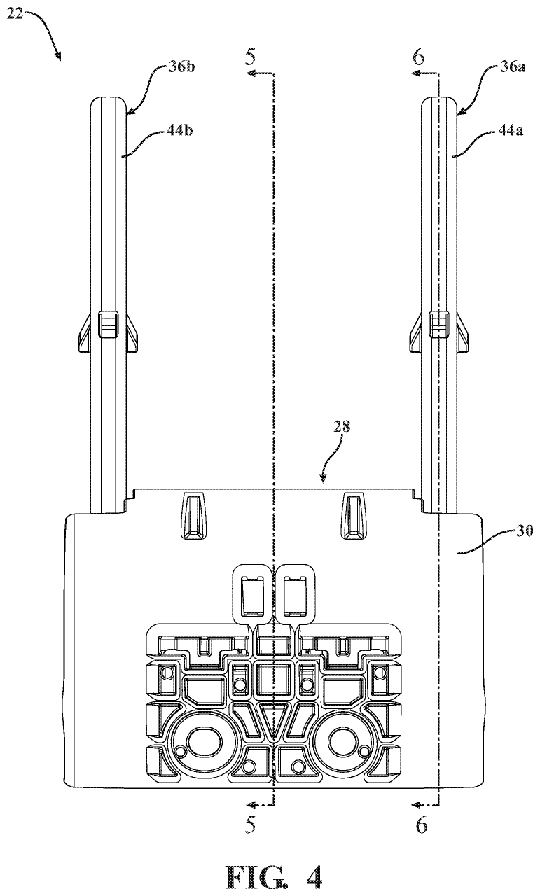

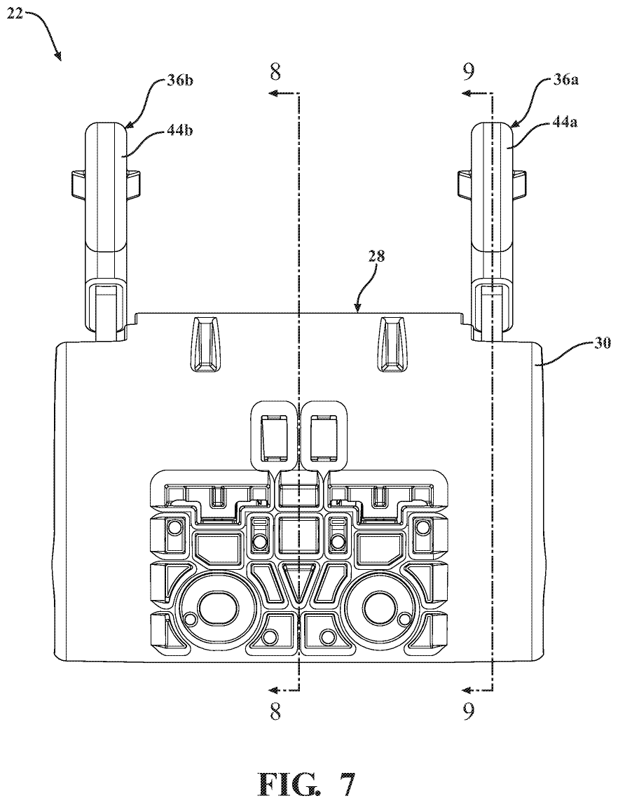

The head restraint assembly 22 also includes arms 36a, 36b coupled to the frame 28 and rotatable relative to the frame 28 about an arm axis AX. In the configuration illustrated in FIG. 1, the frame 28 is shown coupled to the seat back member 24 and the arms 36a, 36b are coupled to the head rest member 26. The seat back member 24 may be referred to as a backrest. The arms 36a, 36b may be referred to as head rest posts. The arms 36a, 36b are rotatable relative to the frame 28 to a lowered position, a raised position, and intermediate positions between the raised and lowered positions. In some configurations, the raised position may be referred to as an upright position. In some configurations, the lowered position may be referred to as a folded position. The arms 36a, 36b are shown in a raised position in FIGS. 3-6B. The arms 36a, 36b are shown in a lowered position in FIGS. 7-9. While the head restraint assembly 22 is shown as employing two arms 36a, 36b, it is contemplated that three or more arms may be employed. It is also contemplated that a single arm may be employed. It is further contemplated that the frame 28 could be coupled to the head rest member 26 and the arms 36a, 36b could be coupled to the seat back member 24.

As shown in the configuration illustrated in FIG. 2, the head restraint assembly 22 may include an arm shaft 38 coupled to the frame 28. The arm shaft 38 couples the arms 36a, 36b to the frame 28 and facilitates rotation of the arms 36a, 36b relative to the frame 28. The arm shaft 38 is rotatable relative to the frame 28 about the arm axis AX. The arm shaft 38 is secured to both the arms 36a, 36b such that the arm shaft 38 and both arms 36a, 36b rotate about the arm axis AX in unison. The arms 36a, 36b may comprise arm members 46a, 46b extending from a proximal end that is coupled to the arm shaft 38 to a distal end disposed away from the frame 28. The arm members 46a, 46b may comprise a metal such as steel. Each arm 36a, 36b may comprise an overmolding 44a, 44b secured to the arm member 46a, 46b and at least partially surrounding the distal end of the arm members 46a, 46b to assist in coupling the head rest member 24 (e.g., a head cushion) to the arms 36a, 36b. The overmoldings 44a, 44b may comprise a polymeric material such as plastic. The arm members 46a, 46b may be molded into the overmoldings 44a, 44b.

As shown in FIG. 2, a proximal portion of each of the arm members 46a, 46b adjacent the proximal end may define a non-circular opening 40a, 40b to receive the arm shaft 38. The arm shaft 38 may comprise arm shaft end portions 42a, 42b. The arm shaft end portions 42a, 42b may have a non-circular cross-section received within the non-circular opening 40a, 40b of the arm members 46a, 46b to prevent relative rotation between the arms 36a, 36b and the arm shaft 38 when the arm shaft 39 is rotated about the arm axis AX. In other configurations, one or both the arms 36a, 36b may be secured to the arm shaft 38 in another manner such that the arms 36a, 36b and the arm shaft 38 rotate in unison.

An arm biasing member 78 may be coupled to the arms 36a, 36b or the arm shaft 38 to urge the arms 36a, 36b toward the lowered position. In the configuration illustrated in FIG. 2, the arm biasing member 78 is realized as a torsion spring surrounding a portion of the arm shaft 38 and coupled to the arm shaft 38 and the frame 28. It is contemplated that other biasing members may be employed to urge the arms to the lowered positions. In other configurations, one or both the arms 36a, 36b may be coupled to the frame 28 without an arm shaft 38 extending between the arms 36a, 36b. In such a configuration, the arms 36a, 36b may be independently coupled to the frame 28.

Referring to FIGS. 2, 6B, and 9, the frame 28 may comprise tracks 48a (only one shown in the figures) for guiding rotation of each of the arms 36a, 36b. The tracks 48a may each define a slot 50a. The arms 36a, 36b may each comprise a pin 52a, 52b configured to be received within one of the slots 50a. The pins 52a, 52b are moveable in the slots 50a between raised and lowered positions of the arms 36a, 36b. Each track 48a may comprise a first end surface defining a first end of the slot 50a and a second end surface defining a second end of the slot 50a. The pins 52a, 52b may abut the first end surface in the raised position and the pins 52a, 52b may abut the second end surface in the lowered position. In this manner, the raised and lowered positions of the arm may be constrained by the position of the pins 52a, 52b within the slots 50a. While the configurations illustrated in the figures show the track 48a and the slot 50a for one of the arms 36a, it is contemplated that the track and slot corresponding to the other arm 36b are formed as mirror images of the shown track 48a and slot 50a.

As shown in FIG. 2, the head restraint assembly 22 comprises an actuation shaft 34 that is coupled to the frame 28. The actuation shaft 34 is rotatable relative to the frame 28 about a shaft axis SX. The shaft axis SX is spaced from the arm axis AX. In some configurations, the arms 36a, 36b are shaped to abut the actuation shaft 34 in the raised position and the shape of the arm members 46a, 46b and position of the actuation shaft 34 when the arms 36a, 36b abut the actuation shaft 34 define the raised position of the arms 36a, 36b. In other words, the actuation shaft 34 prevents rotation of the arms 36a, 36b past the raised position.

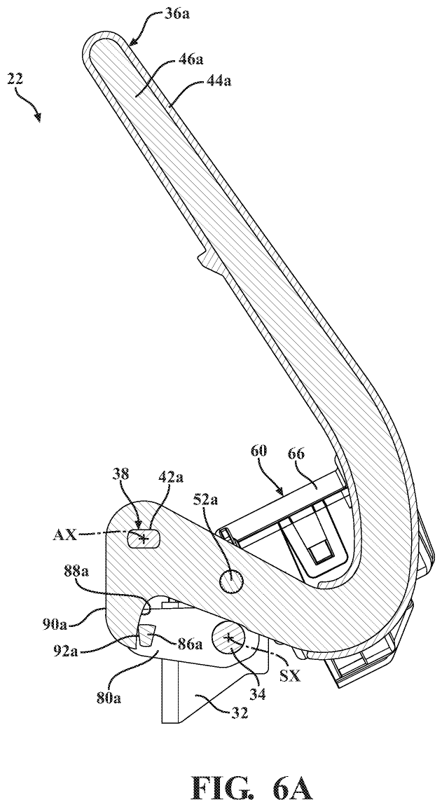

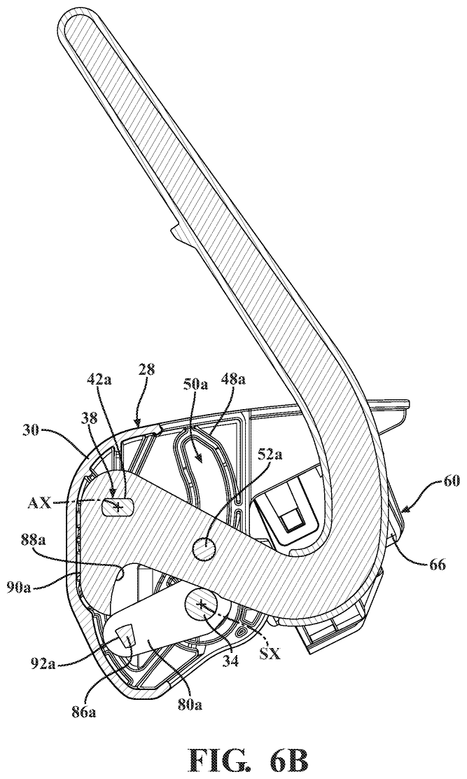

One or more pawls 54a, 54b are coupled to the actuation shaft 34. The pawls 54a, 54b are rotatable with the actuation shaft 34 about the shaft axis SX to an engaged position, shown in FIG. 6A, in which rotation of the arms 36a, 36b from the raised position to the lowered position is prevented. The pawls 54a, 54b are rotatable with the actuation shaft 34 about the shaft axis SX to a released position, shown in FIG. 6B, in which rotation of the arms 36a, 36b from the raised position to the lowered position is permitted. In the configuration illustrated in FIGS. 2 and 3, the pawls 54a, 54b are mounted directly to the actuation shaft 34 such that the pawls 54a, 54b surround at least a portion of the actuation shaft 34. The pawls 54a, 54b are described in greater detail further below in connection with engagement between the pawls 54a, 54b and the arms 36a, 36b.

The actuation shaft 34 may comprise an elongated shaft body 35 and an actuation finger 72 that is used to rotate the actuation shaft 34 in response to an actuator 60. The actuation finger 72 may be fastened to the actuation shaft 34 via a fastener extending through an actuation sleeve 74 that surrounds the elongated shaft body 35. A shaft biasing member 76 may be coupled to the actuation shaft 34 and configured to urge the actuation finger 72 toward the actuator 60. In the configuration illustrated in FIGS. 2 and 3, the shaft biasing member 76 is realized as a torsion spring at least partially surrounding the actuation shaft 34 and coupled to the actuation shaft 34 and the frame 28. It is contemplated that other biasing members may be employed to urge the actuation finger 72 toward the actuator 60.

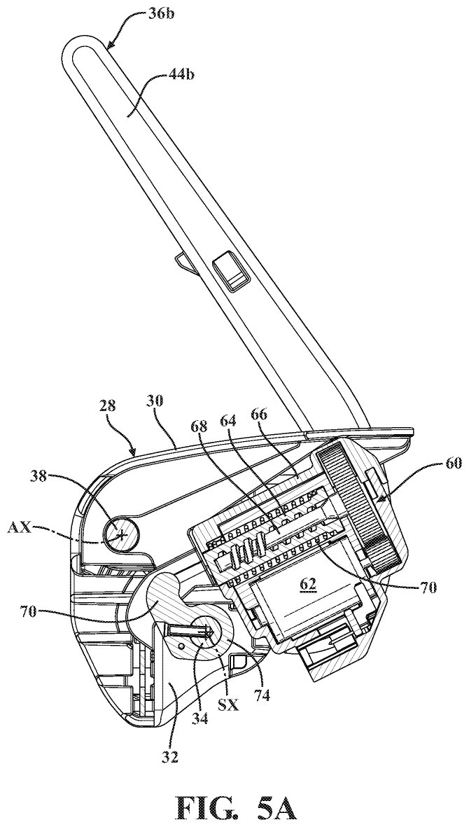

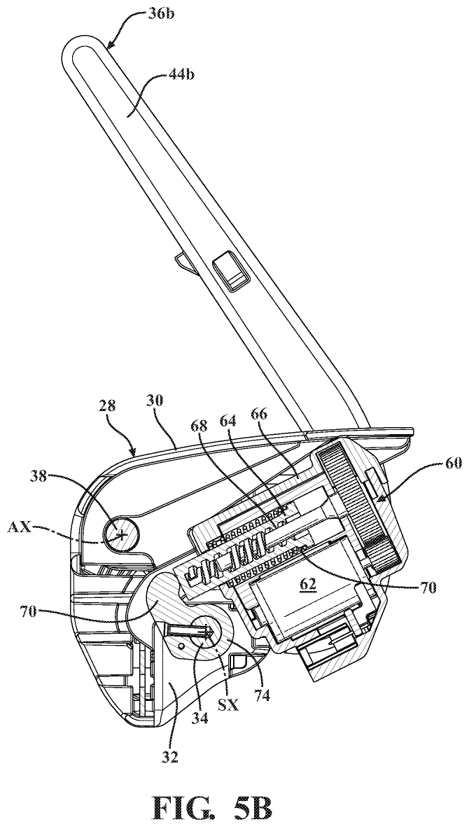

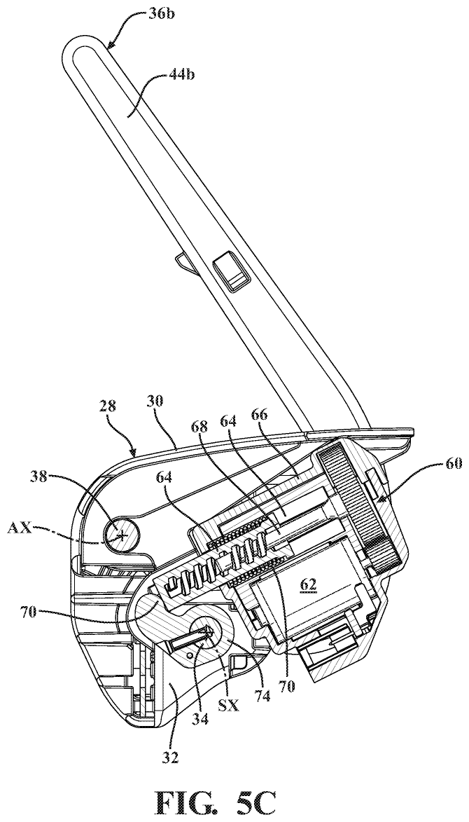

As noted briefly above and as shown in FIGS. 5A-5C, the head restraint assembly 22 includes an actuator 60 coupled to the frame 28. The actuator 60 may be connected directly to the frame. The actuator 60 is operable to selectively rotate the actuation shaft 34 by engaging the actuation finger 72. The actuator 60 has an electric motor 62 and a drive plunger 64. The actuator 60 may further comprise an actuator body 66. The drive plunger 64 is moveable relative to the body 66 to an extended position, shown in FIG. 5C, and a retracted position, shown in FIG. 5A. In the extended position, a distal end of the drive plunger 64 that engages the actuation finger 72 extends a first distance away from the body 66. In the retracted position, the distal end of the drive plunger 64 extends away from the body 66 at a second distance less than the first distance. One advantage of employing an electric motor 62 with the actuator 60 is that manual manipulation by a user to move the arms 36a, 36b to the lowered position is unnecessary. Furthermore, utilization of an electric motor 62 in the actuator 60 may permit the actuator 60 to be self-contained on the head rest assembly 22. In other words, the actuator 60 would not require cooperation with components of the seat back member 24 or the head rest member 26 that are not part of the head restraint assembly 22 to facilitate movement of the arms 36a, 36b and the head rest member 26 to the lowered position.

Actuation of the electric motor 62 causes the drive plunger 64 to extend outwardly from an actuator body 66 to rotate the actuation shaft 34 to move the pawls 54a, 54b to the released positions. More specifically, the actuator 60 may comprise a driver 68 that rotates in response to receiving torque from an armature of the electric motor 62. The driver 68 may be complementarily threaded with the drive plunger 64 such that rotation of the driver 68 imparts linear movement of the drive plunger 64 to extend the distal end of the drive plunger 64 away from the body 66 and into engagement with the actuation finger 72. In other words, the drive plunger 64 and the driver 68 may comprise a lead screw arrangement. In this manner, the actuator 60 may comprise a linear actuator. It is contemplated that the actuator 60, including the electric motor 62, may be configured differently. For example, the armature of the electric motor 62 may connect directly to the drive plunger 64. It is contemplated that the actuator 60 may be configured differently to extend and retract the drive plunger 64 relative to the actuator body 66 with the electric motor 62.

The actuator 60 is operable between a powered state in which the electric motor 62 is energized to move the drive plunger 64 to the extended position. The actuator 60 is operable in an unpowered state in which the electric motor 62 is not energized. The actuator 60 may comprise an actuator biasing member 70 to urge the drive plunger 64 to the retracted position. In the powered state, force exerted on the drive plunger 64 by the electric motor 62 and the driver 68 overcome the spring force to move the drive plunger 64 toward the extended position. In the unpowered state, the actuator biasing member 70 returns the drive plunger 64 to the retracted position. In the unpowered state, the electric motor 62 may be back driven by the actuator biasing member 70. In other configurations, the electric motor 62 may be disconnected from the driver 68 to allow the drive plunger 64 to return to the retracted position.

In one configuration shown in FIG. 5B, the drive plunger 64 is moveable relative to the body 66 to an intermediate position between the extended and retracted positions. In the intermediate position, the end of the drive plunger 64 extends a third distance away from the body 66 between the first and second distances. In configurations employing an intermediate position, the actuator 60 may be operable in a first powered state associated with the extended position of the drive plunger 64 and a second powered state associated with the intermediate position of the drive plunger 64.

As shown in FIGS. 5A-5C, the drive plunger 64 may be spaced from the actuation finger 72 in the retracted position (FIG. 5A) such that no portion of the drive plunger 64 is in contact with the actuation finger 72. In one configuration of drive plunger 64 in the intermediate position (FIG. 5B), the drive plunger 64 may extend from the body 66 at the third distance. In the illustrated configuration, the drive plunger 64 may abut the actuation finger 72 in the intermediate position, but not move the actuation finger 72. In an alternative configuration, the drive plunger 64 may be spaced from the actuation finger 72 in the intermediate position. In the alternative configuration, the drive plunger 64 may still be spaced from the actuation finger 72 in the intermediate position, but the drive plunger 64 would be closer to the actuation finger 72 in the intermediate position than in the retracted position. In the extended position (FIG. 5C), the drive plunger 64 abuts the actuation finger 72 and rotates the actuation finger 72 with the actuation shaft 34 about the shaft axis SX.

As shown in FIGS. 3, 6A, and 6B, each of the pawls 54a, 54b may comprise a first lever portion 80a, 80b coupled to the actuation shaft 34 and an abutment portion 86a, 86b extending from the first lever portion 80a, 80b to abut the arms 36a, 36b. In the configuration illustrated in FIGS. 3, 6A, and 6B, each of the pawls 54a, 54b also comprise a second lever portion 82a, 82b coupled to the actuation shaft 34 and spaced from the associated first lever portions 80a, 80b with one of the abutment portions 86a, 86b disposed between the first and second lever portions 80a, 80b, 82a, 82b. It is contemplated that in other configurations, a single lever portion may be employed.

As shown in FIG. 2, the second lever portions 82a, 82b may define a non-circular opening 56a, 56b to receive the actuation shaft 34. The actuation shaft 34 may comprise actuation shaft end portions 58a, 58b. The actuation shaft end portions 58a, 58b may each have a non-circular cross-section received within one of the non-circular openings 56a, 56b of the second lever portions 82a, 82b to prevent relative rotation between the pawls 54a, 54b and the actuation shaft 34 when the actuation shaft 34 is rotated about the arm axis AX. In the configuration illustrated in FIG. 2, the first lever portions 80a, 80b may define a circular opening 84a, 84b to receive the actuation shaft 34. It is contemplated that each of the first lever portions 80a, 80b may instead or additionally define a non-circular opening to receive the actuation shaft 34 and the second lever portions 82a, 82b may define a circular opening instead. In other configurations, one or both the pawls 54a, 54b may be secured to the actuation shaft 34 in another manner such that the pawls 54a, 54b and the actuation shaft 34 rotate in unison.

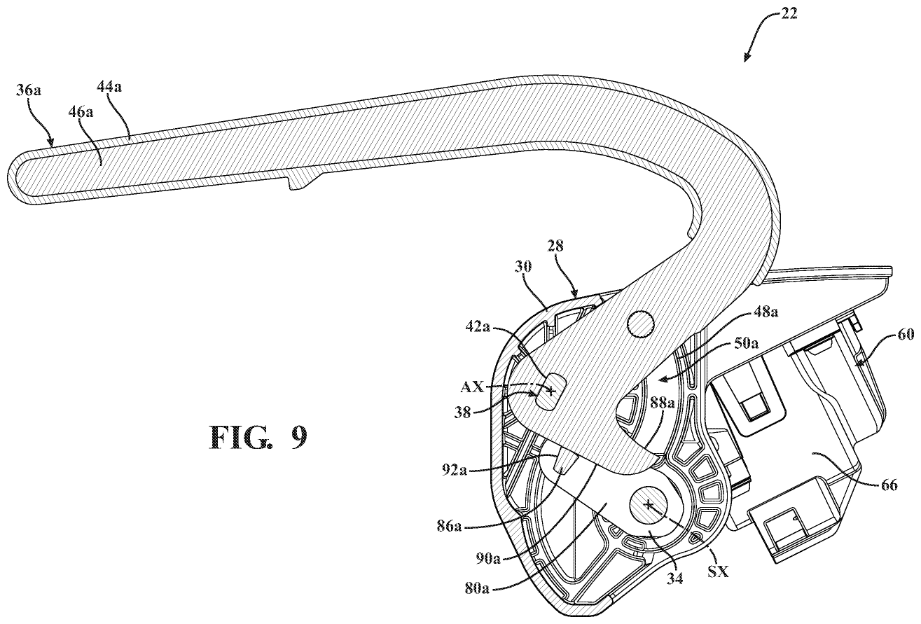

As shown in FIGS. 6A, 6B, 8, and 9, the abutment portions 86a, 86b of the pawls 54a, 54b in the engaged position abut the arms 36a, 36b in the raised position (FIG. 6A) to prevent the arms 36a, 36b from moving to the lowered position. As noted above, the shaft biasing member 76 urges the actuation finger 72 toward the actuator 60. The shaft biasing member 76 also urges the pawls 54a, 54b, through the actuation shaft 34, to lock the arms 36a, 36b in the raised position. When the arms 36a, 36b are locked, the arms 36a, 36b may not be moved absent operation of the actuator 60. In the released position (FIG. 6B), the abutment portions 86a, 86b are spaced from the arms 36a, 36b to permit the arms 36a, 36b to move to the lowered position (FIG. 9). More specifically, movement of the abutment portions 86a, 86b away from the arms 36a, 36b allows the arm biasing member 78 to rotate the arms 36a, 36b from the raised position to the lowered position. In the lowered positions, the distance between the drive plunger 64 in the retracted position and the actuation finger 72 may be less than the distance between the drive plunger 64 in the retracted position and the actuation finger 72 when the arms are in the raised positions.

The arms 36a, 36b may each comprise a restraining surface 88a, 88b and a following surface 90a, 90b. Each of the restraining surfaces 88a, 88b and the following surfaces 90a, 90b are configured to abut one of the abutment portions 86a, 86b. The restraining surfaces 88a, 88b may comprise a concave shape and the following surfaces 90a, 90b may comprise a convex shape. The restraining surfaces 88a, 88b and the associated following surfaces 90a, 90b may be formed to meet at a corner. This arrangement prevents the abutment portions 86a, 86b from abutting both of the surfaces 88a, 88b, 90a, 90b at the same time.

The abutment portions 86a, 86b abuts the restraining surfaces 88a, 88b to prevent the arms 36a, 36b from moving to the lowered position. The abutment portions 86a, 86b abuts the following surfaces 90a, 90b when the arms 36a, 36b are not in the raised position in order to quickly return to the engaged position when a user manipulates the arms 36a, 36b from the lowered position to the raised position. In the configuration shown in FIGS. 6A, 6B and 9, the abutment portions 86a, 86b slide against at least a portion of the restraining surface 88a, 88b of the arms 36a, 36b before separating from restraining surfaces 88a, 88b as the pawls 54a, 54b move to the released positions. The sliding of the abutment portions 86a, 86b against the restraining surfaces 88a, 88b prevents unintended release of the arms 36a, 36b from the raised position to the lowered position. Employing an arc on the restraining surfaces 88a, 88b allows the arms 36a, 36b to remain static while the abutment portions 86a, 86b slide against the restraining surfaces 88a, 88b from the engaged position to the released position. In other configurations, the arc of the restraining surfaces 88a, 88b may not be centered at the shaft axis SX in any position of the arms 36a, 36b. The abutment portions 86a, 86b may each comprise flat surfaces 92a, 92b, 93a, 93b producing one or more corners to engage the restraining surfaces 88a, 88b and following surfaces 90a, 90b, respectively. As noted above, the restraining surfaces 88a, 88b and the associated following surfaces 90a, 90b of the arm 36a, 36b may be formed to meet at a corner. The arrangement of the corners of the abutment portions 86a, 86b and the corners of the arm members 36a, 36b prevent false locking i.e., the corner-to-corner engagement mitigates an occurrence of the arms 36a, 36b being in a raised position, but the abutment portions 86a, 86b not sliding past the following surfaces 90a, 90b and into engagement with the restraining surfaces 88a, 88b. The flat surfaces 92a, 92b, 93a, 93b may be oriented to be non-parallel relative to the restraining surfaces 88a, 88b and the following surfaces 90a, 90b.

Beginning with FIGS. 3, 5A, and 6A, one exemplary configuration of an operation to lower the head rest member 26 and move the arms 36a, 36b from the raised position to the lowered position is described. The arms 36a, 36b may begin in the raised position, the actuator 60 may be in the unpowered state with the drive plunger 64 in the retracted position, and the pawls 54a, 54b may be in the engaged positions with the abutment portions 86a, 86b abutting the restraining surfaces 88a, 88b.

With reference to FIGS. 5B, 5C, and 6B, and continuing the exemplary configuration above, to lower the arms 36a, 36b and thus, the head rest member 26, the user may remotely, e.g., with a user input device such as a button or touch screen device, send a signal to the actuator 60 to operate the actuator 60 in the powered state. When the seat associated with head restraint assembly 22 is vacant, the user would likely be a driver who desires better rear visibility. In the powered state, the electric motor 62 generates torque and rotates the driver 68 to move the drive plunger 64 toward the extended position, abutting actuation finger 72 and rotating the actuation finger 72, the actuation shaft 34, and the pawls 54a, 54b about the shaft axis SX (FIG. 5B). As the pawls 54a, 54b rotate about the shaft axis SX, the abutment portions 86a, 86b slide against the restraining surfaces 88a, 88b until the abutment portions 86a, 86b pass over the restraining surfaces 88a, 88b (FIG. 6B). The actuator 60 remains in the powered state at least as long as it takes for the arm biasing member 78 to move the arms 36a, 36b toward the lowered positions.

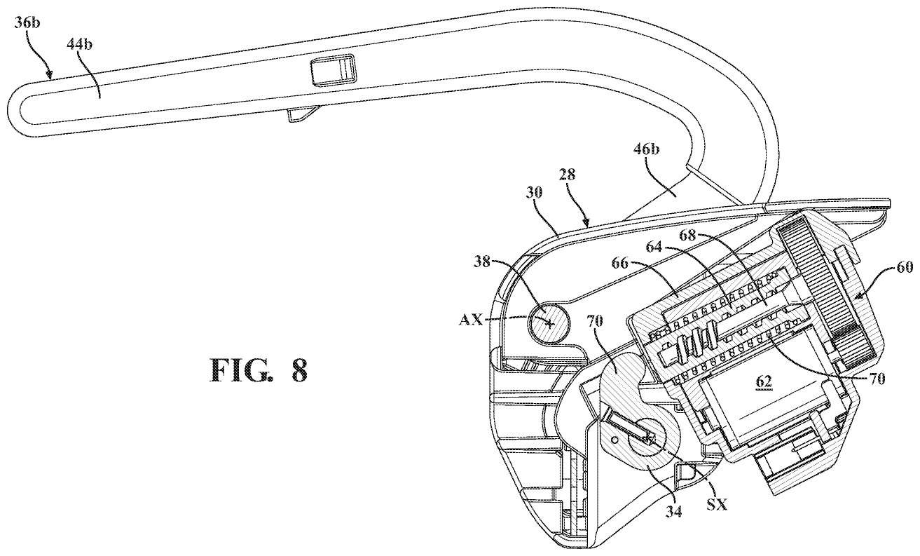

With reference to FIGS. 8 and 9, as the arms 36a, 36b move toward the lowered position or alternatively when the arms 36a, 36b are in the lowered positions, the actuator 60 is operated in the unpowered state and the actuator biasing member 70 returns the drive plunger 64 to the retracted position (FIG. 8). The shaft biasing member 76 urges the actuation finger 72 toward the drive plunger 64 but is limited by the abutment portions 86a, 86b abutting the following surfaces 90a, 90b of the arms 36a, 36b by virtue of the actuation finger 72, actuation shaft 34, and pawls 54a, 54b all being secured together. To return the head rest member 26 and the arms 36a, 36b to the raised positions, a user, often a different user than the driver such as a passenger who is intending to sit in the associated seat, manually manipulates the head rest member 26 and the arms 36a, 36b to move the arms 36a, 36b to the raised position. As the actuator 60 is no longer abutting the actuation finger 72, the shaft biasing member 76 urges the pawls 54a, 54b toward the engaged position. Once the abutment portions 86a, 86b clear the following surfaces 90a, 90b, the shaft biasing member 76 may overcome the arm biasing member 78 to urge the arms 36a, 36b to the raised portion until either the pins 52a abut the first end of the slots 50a or until the arms 36a, 36b abut the actuation shaft 34.

Several examples have been discussed in the foregoing description. However, the examples discussed herein are not intended to be exhaustive or limit the invention to any particular form. The terminology that has been used is intended to be in the nature of words of description rather than of limitation. Many modifications and variations are possible in light of the above teachings and the invention may be practiced otherwise than as specifically described.

1. A head restraint assembly comprising:
a frame;
a shaft coupled to the frame and rotatable relative to the frame about a shaft axis;
an arm coupled to the frame and rotatable relative to the frame about an arm axis to at least a lowered position and a raised position with the arm axis spaced from the shaft axis;
a pawl coupled to the shaft and rotatable with the shaft about the shaft axis to an engaged position in which rotation of the arm from the raised position to the lowered position is prevented and to a released position in which rotation of the arm from the raised position to the lowered position is permitted; and
an actuator being connected directly to the frame and having an electric motor and a drive plunger, with actuation of the drive plunger rotating the shaft to move the pawl to the released position.

2. The head restraint assembly of claim 1, wherein the pawl is mounted directly to the shaft.

3. The head restraint assembly of claim 2, wherein the pawl defines a non-circular opening to receive the shaft, and wherein at least a portion of the shaft comprises a non-circular cross-section received within the non-circular opening of the pawl to prevent relative rotation between the pawl and the shaft when the shaft is rotated about the shaft axis.

4. (canceled)

5. The head restraint assembly of claim 1, wherein the shaft comprises an actuation finger and wherein the drive plunger is engageable with the actuation finger to rotate the shaft to move the pawl to the released position.

6. The head restraint assembly of claim 5, wherein the actuator comprises a body, with the drive plunger being moveable relative to the body to an extended position in which an end of the drive plunger extends a first distance away from the body and a retracted position in which the end of the drive plunger extends away from the body at a second distance less than the first distance.

7. The head restraint assembly of claim 6, wherein the actuator comprises an actuator biasing member and wherein the actuator is operable between a powered state in which the drive plunger is moved to the extended position, and an unpowered state in which the actuator biasing member returns the drive plunger to the retracted position.

8. The head restraint assembly of claim 7, wherein the drive plunger is moveable relative to the body to an intermediate position in which the end of the drive plunger extends a third distance away from the body between the first and second distances, and wherein the powered state is further defined as a first powered state and the actuator is operable to a second powered state in which the drive plunger is moved to the intermediate position.

9. The head restraint assembly of claim 8, further comprising a shaft biasing member to bias the actuation finger toward the drive plunger of the actuator.

10. The head restraint assembly of claim 8, wherein the drive plunger is spaced from the actuation finger in the retracted position.

11. The head restraint assembly of claim 8, wherein the drive plunger abuts the actuation finger in the extended position.

12. The head restraint assembly of claim 1, further comprising an arm biasing member coupled to the arm and the frame urging the arm to the lowered position.

13. The head restraint assembly of claim 1, wherein the pawl comprises a lever portion coupled to the shaft and an abutment portion extending from the lever portion to abut the arm, and wherein the abutment portion of the pawl in the engaged position abuts the arm in the raised position to prevent the arm from moving to the lowered position and wherein the abutment portion of the pawl in the released position is spaced from the arm to permit the arm to move to the lowered position.

14. (canceled)

15. (canceled)

16. The head restraint assembly of claim 13, wherein the arm comprises a restraining surface and a following surface, each of the restraining surface and the following surface formed to abut the abutment portion of the pawl.

17. The head restraint assembly of claim 16, wherein the abutment portion comprises a flat surface oriented to be non-parallel relative to the restraining surface.

18. The head restraint assembly of claim 16, wherein the restraining surface is concave and the following surface is convex.

19. The head restraint assembly of claim 13, wherein the lever portion comprises a first lever portion and the pawl comprises a second lever portion spaced from the first lever portion with the abutment portion disposed between the first and second lever portions.

20. The head restraint assembly of claim 19, wherein one of the lever portions defines a non-circular opening to receive a non-circular portion of the shaft and wherein the other one of the lever portions defines a circular opening to receive a circular portion of the shaft.

21. The head restraint assembly of claim 1, wherein the actuator comprises a linear actuator.

22. The head restraint assembly of claim 1, wherein the frame comprises a track defining a slot and wherein the arm comprises a pin received within the slot and wherein the pin is moveable within the slot between raised and lowered positions of the arm, and wherein the track comprises a first end surface defining a first end of the slot and a second end surface defining a second end of the slot, and wherein the pin abuts the second end surface when the arm is in the lowered position.

23. (canceled)

24. The head restraint assembly of claim 1, further comprising a second arm and a second pawl, the second arm coupled to the frame and spaced from the first arm, with the second arm rotatable relative to the frame with the first arm, and the second pawl coupled to the shaft and spaced from the first pawl, with the second pawl rotatable with the first pawl to an engaged position in which rotation of the second arm from the raised position to the lowered position is prevented and to a released position in which rotation of the second arm from the raised position to the lowered position is permitted.

25. The head restraint assembly of claim 24, wherein the actuator is disposed between the first and second pawls.

26. A method of operating a head restraint assembly having a frame, a shaft rotatable relative to the frame, an arm rotatable relative to the frame, a pawl rotatable relative to the frame, and an actuator coupled to the frame and having an electric motor and a drive plunger, the method comprising the steps of:
moving the drive plunger with the electric motor from a retracted position to an extended position to rotate the shaft about a shaft axis, and
rotating the pawl about the shaft axis to a released position to permit movement of the arm from a raised position to a lowered position.

27. The method of claim 26, further comprising the step of moving the drive plunger with the electric motor to an intermediate position between the extended and retracted positions.

28. The method of claim 26, wherein the shaft includes an actuation finger, the method further comprising the steps of:
moving the drive plunger from the retracted position in which the drive plunger is spaced from the actuation finger to the extended position in which the drive plunger abuts the actuation finger, and
rotating the actuation finger and the shaft to move the pawl to the released position.

29. (canceled)
